(19) United States
(12) Patent Application Publication
(10) Pub. No.: US 2011/0025482 A1
(43) Pub. Date: Feb. 3, 2011

(54) METHOD AND SYSTEM FOR RECOGNIZING THE STATE OF CONNECTION OF CONNECTORS

(76) Inventors: José Manuel Algüera, Aschaffenburg (DE); Michael Eiermann, Pfungstadt (DE)

Correspondence Address: INDIANAPOLIS OFFICE 27879;BRINKS HOFER GILSON & LIONE, CAPITAL CENTER, SUITE 1100, 201 NORTH ILLINOIS STREET, INDIANAPOLIS, IN, 46204-4220, US

(21) Appl. No.: 12/921,914

(22) PCT Filed: Mar. 12, 2009
(86) PCT No.: PCT/EP2009/052941

§ 371 Date: Sep. 10, 2010

(30) Foreign Application Priority Data
Mar. 13, 2008 (DE) 10 2008 014 573.4

(51) Int. Cl. G08B 21/00

(52) U.S. Cl. 340/431

(57) ABSTRACT

A method and a system for recognizing the state of connection between a first connector half (3) of a towing vehicle (1) and a second connector half (4) of a trailer vehicle (2) in which the trailer vehicle (2) has at least one pneumatic circuit (5), the pressure level of which is detected by a pressure sensor (6) and is provided as an electronic signal to the towing vehicle (1) by means of a trailer control device (7) to render optical control of the correct connection of the connector halves (3, 4) unnecessary. The electronic signal is read by a control device (8) on the vehicle side and a return message about the connection state is displayed by means of a signal device (15).

### BACKGROUND

The invention relates to a method and a system for detecting the connection state between a first connector half of a towing vehicle and a second connector half of a trailer vehicle.

The term towing vehicle refers in particular to a semitrailer tractor, while the term trailer vehicle refers to a semitrailer. The purpose of the connector halves is to connect the supply lines from the towing vehicle to trailer vehicle, through which lines the trailer vehicle is supplied with electric power and compressed air, in particular, for the pneumatic brake circuit. Immediately after the supply lines are connected, the compressed air flows from the towing vehicle into the pneumatic brake circuit until a specified pressure level is attained. The brakes of the trailer vehicle can only be released once a specified pressure level has been attained that is detected by the pressure sensor. A method that is described as outlined above along with a corresponding power transmission system can be found, for example, in DE 10 2004 047 492 A1.

The purpose of the known power transmission system of DE 10 2004 047 492 A1 is to relieve the connector coupling system by an approach wherein the power from the power supply system is transmitted to the power distribution line only in controlled fashion, and thus only temporarily. As a result, the connector halves in turn are only impinged temporarily by a flow of current or compressed air, thereby reducing wear significantly. The control of the power transmission system occurs without any intervention by the driver. Similarly, the driver receives essentially no information on the function-ready connection between connector halves, so must consequently leave the vehicle to verify the proper connection between connector halves.

As a result, the object of the invention is to provide a method or a system that dispenses with the need for visual monitoring of the proper connection between connector halves.

### SUMMARY

The object is achieved according to the invention by an approach wherein the electronic signal is read by a towing-vehicle-side control device, and a check-back message on the connection state is displayed by a signal unit. The signal unit here can display the connection state directly, or can offer the driver, for example, information on performing further procedures, such as retracting the telescopic landing gear.

The provision of the pressure level on the trailer vehicle is detected so as to be able to confirm there is a properly functioning connection between the connector halves. In such cases where the connector halves have not effectively engaged—for example, because one of the connector halves is damaged, the specified pressure level fails to be reached.

The system according to the invention comprises a control device to process the electronic signal, which device is disposed on the towing vehicle and connected to the trailer control device, and a signal unit that displays the connection status to the driver.

In an advantageous embodiment, the trailer control device and/or the control device is a component of the electronic brake system (EBS) of the articulated truck. Scanning the pressure level on the trailer vehicle is generally effected in modern vehicles through the electronic brake system.

The electronic signal is preferably placed on the databus, where the electronic signal transmitted through the databus is able to be read by the control device on the towing vehicle. The brake pressure signal, among others, is communicated electronically through the databus to the trailer vehicle. The databus relates, in particular, to a CAN bus.

The control device of the towing vehicle advantageously compares the incoming electronic signal from the trailer control device with the stored brake pressure signal. Enhanced operational reliability is achieved thereby since it is not only the pressure increase in brake pressure, but also the databus along with the associated control devices and the proper connection of the pole of the databus that are incorporated in the checking procedure.

It has proven to be especially advantageous if the contacts for transferring the databus signal are provided on the first and second connector halves. For towing vehicles and semitrailers, currently seven-pole connector halves exist based on ISO 7638 as the prescribed standard in which poles 1 through 5 are assigned to power transmission and for a warning light control. The two other poles are provided for databus transmission according to ISO 11992.

If an automatic coupling system is used for semitrailer units, the first connector half should be disposed directly below the entry opening of the fifth-wheel coupling. The second connector half can be positioned on an alignment wedge that is swivelably supported on a king pin, where the outer contour of the alignment wedge is of complementary form relative to the entry opening of the fifth-wheel coupling. When the semitrailer is hitched, the connector halves of towing vehicle and semitrailer simultaneously move into effective engagement with each other. This occurs in a region underneath the entry opening of the fifth-wheel coupling that is virtually nonobservable from the outside. For this reason, the use of the system according to the invention on semitrailer units having an automatic coupling system is especially advantageous since the previously required visible check is essentially impossible to perform due to the inaccessible installation position. As soon as the connector halves of towing vehicle and trailer vehicle have been connected to each other, the pressure level on the trailer is read through the pressure sensor and relayed to the trailer control device. The trailer control device sends a corresponding signal to the databus that is read by the towing-vehicle-side control device and identified as the pressure level present at the trailer.

The signal unit is preferably disposed in the cab. The signal unit relays to the driver the information about the proper connection between connector halves without the driver's having to leave the cab.

### BRIEF DESCRIPTION OF THE DRAWINGS

The following discussion describes the invention in more detail to provide further explanation based on two figures. In the figures:

FIG. 1 is a side view of a semitrailer unit including a towing vehicle and a trailer vehicle; and

FIG. 2 is a schematic function block diagram of essential components of the system according to the invention.

### DESCRIPTION OF PREFERRED EMBODIMENTS

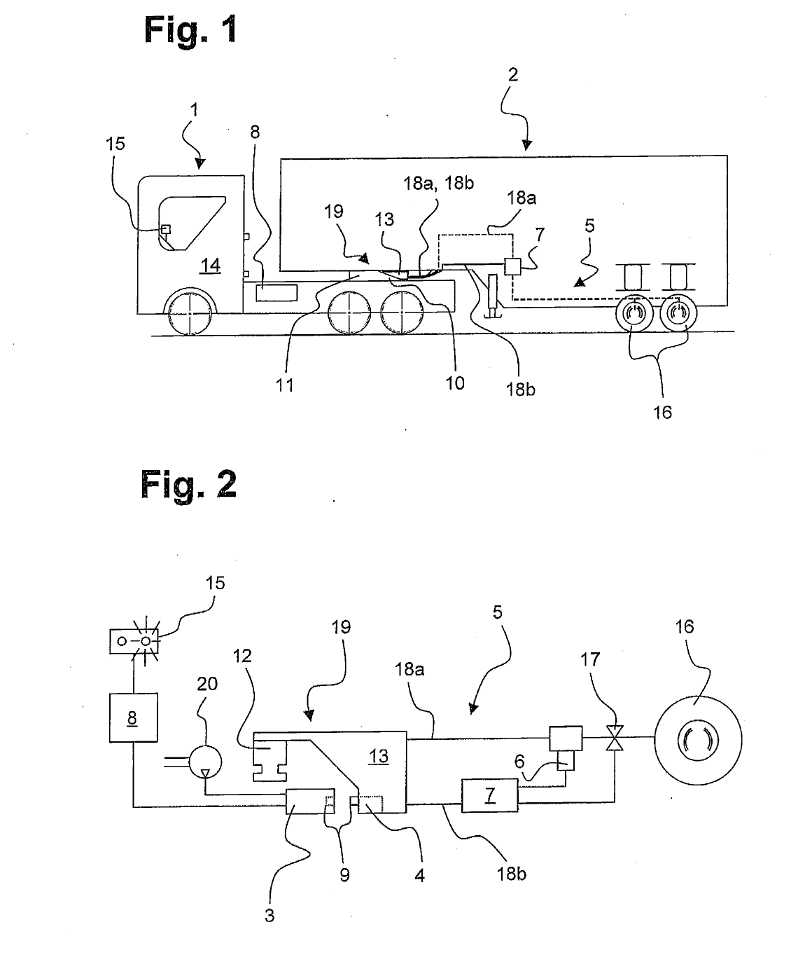

FIG. 1 is a side view illustrating a towing vehicle 1 including a trailer vehicle 2, in the form of a semitrailer, that is mechanically connected thereto. In order to hitch up semitrailer 2, towing vehicle 1 drives in reverse towards stationary semitrailer 2 such that a king pin 12 (see FIG. 2) attached to the bottom of semitrailer 2 first moves into a tapered entry opening 10 of a fifth-wheel coupling 11 where it is positively guided into its end position within fifth-wheel coupling 11.

The transmission of power and control signals is effected, not through the conventional approach through coiled cables running from towing vehicle 1 to semitrailer 2, but through a coupling system 19.

Coupling system 19 on the towing vehicle side comprises a first connector half 3 disposed in stationary fashion below entry opening 10, the connector half including contacts 9 that, aside from a power source not shown, are connected to a compressor 20 to supply compressed air. In addition, first connector half 3 is connected to a control device 8 of towing vehicle 1, which device communicates through a databus to the components located on semitrailer 2 and is an integral component of the electronic brake system.

Control device 8 is connected to a signal unit 15 disposed in the cab 14 of towing vehicle 1, which unit informs the driver whether there is a proper connection between first and second connector halves 3, 4.

Coupling system 19 furthermore comprises an alignment wedge 13 (see FIG. 2) swivelable about king pin 12, the outer shape of the wedge being of complementary form to the geometry of entry opening 10. A second connector half 4 is located on the bottom of alignment wedge 13, as is also illustrated especially clearly in FIG. 2. When king pin 12 is hitched to fifth-wheel coupling 11, both connector halves 3, 4 are brought together. Second connector half 4 also has contacts 9 that before contact is made with first connector half 3 face contacts 9 located therein.

Supply lines emerge from the rear of alignment wedge 13 that include the pneumatic brake signal line 18a and the control line 18b of brake circuit 5.

Pneumatic brake signal line 18a extends along semitrailer 2 from alignment wedge 13 up to the brakes of the relevant wheel 16. Inside pneumatic brake signal line 18a, the pneumatic pressure is detected by pressure sensor 6 that is connected to a trailer control device 7 of the electronic brake system (EBS).

Control line 18b similarly runs from alignment wedge 13 to trailer control device 7. In addition, a brake valve 17 can also be controlled through another branch line by trailer control device 7.

When semitrailer 2 is hitched to towing vehicle 1, first and second connector halves 3, 4 of coupling system 19 are connected to each other. Proper monitoring is now performed in a system-inherent manner, instead of by the driver's visual check, by an approach wherein the pressure present in pneumatic brake signal line 18a after connection is measured by pressure sensor 6 disposed therein and is stored in the databus inside trailer control device 7. A build-up of pressure within pneumatic brake line 18a occurs only if a proper connection is made between first connector half 3 and second connector half 4, and only then does a signal transmission by the databus occur through first and second connector halves 3, 4, which transmission is detected by control device 8 of towing vehicle 1.

If control device 8 decides that there is a proper connection between connector halves 3, 4, this is displayed to the driver through signal unit 15 within cabin 14.

When compared to a visual check of the connection status between first and second connector halves 3, 4, the system according to the invention provides the advantage that the functioning of brake circuit 5 is verified simultaneously, since otherwise no positive signal would be transmitted through the databus to control device 8 of towing vehicle 1.

### LIST OF REFERENCE NUMERALS

1 towing vehicle
2 trailer vehicle, semitrailer
3 first connector half
4 second connector half
5 pneumatic circuit, brake circuit
6 pressure sensor
7 trailer control device
8 control device, towing vehicle
9 contacts
10 entry opening
11 fifth-wheel coupling
12 king pin
13 alignment wedge
14 cab
15 signal unit
16 wheel, semitrailer
17 brake valve
18a pneumatic brake signal line
18b control line
19 coupling system
20 compressor

1-12. (canceled)

13. Method for detecting the connection state between a first connector half (3) of a towing vehicle (1) and a second connector half (4) of a trailer vehicle (2), in which the trailer vehicle (2) has at least one pneumatic circuit (5), the pressure level of which is detected by a pressure sensor (6) and supplied through a trailer control device (7) as an electronic signal to the towing vehicle (1), the towing vehicle (1) including a CAN bus characterized in that the electronic signal of the pressure sensor (6) is placed by the trailer control device (7) on the CAN bus, that this signal is read by a towing-vehicle-side control device (8), and that a check-back message on the connection state is displayed by a signal unit (15).

14. Method according to claim 13, characterized in that the incoming electronic signal is compared by the control device (8) with the stored brake pressure signal.

15. System for detecting the connection state between a first connector half (3) of a towing vehicle (1) and a second connector half (4) of a trailer vehicle (2), in which the trailer vehicle (2) has at least one pneumatic circuit (5) and a pressure sensor (6) disposed therein, the sensor using a trailer control device (7) to supply an electronic signal to the towing vehicle (1), the towing vehicle (1) having a CAN bus, wherein a control device (8) connected to the trailer control device (7) is disposed on the towing vehicle (1), said control device (8) processing the electronic signal, characterized in that the trailer control device (7) places the electronic signal of the pressure sensor (6) on the CAN bus on the towing vehicle (1), that the electronic signal transmitted through the CAN bus is able to be read by the control device (8) on the towing vehicle, and that a signal unit (15) is disposed on the towing vehicle (1), the unit displaying the connection status to the driver.

16. System according to claim 15, characterized in that the trailer control device (7) and/or the control device (8) is a component of an electronic brake system (EBS).

17. System according to claim 15 or 16, characterized in that the control device (8) compares the incoming electronic signal from the trailer control device (7) with the stored brake pressure signal.

18. System according to claim 15 or 16, characterized in that contacts (9) are provided on the first and second connector halves (3, 4) to transmit the CAN bus signal.

19. System according to claim 15 or 16, characterized in that the first connector half (3) is disposed directly below the entry opening (10) of a fifth-wheel coupling (11).
